(19) United States
(12) Patent Application Publication
(10) Pub. No.: US 2015/0347943 A1
(43) Pub. Date: Dec. 3, 2015

(54) LOAD PROFILE MANAGEMENT AND COST SENSITIVITY ANALYSIS

(71) Applicant: Hunt Energy IQ, LP, Dallas, TX (US)

(72) Inventors: Robert Burke, Dallas, TX (US); Prateek Sangal, Frisco, TX (US)

(21) Appl. No.: 14/819,819

(22) Filed: Aug. 6, 2015

Related U.S. Application Data
(63) Continuation of application No. 13/465,309, filed on May 7, 2012.
(60) Provisional application No. 61/530,646, filed on Sep. 2, 2011.

(51) Int. Cl. G06Q 10/06; G06Q 50/06

(52) U.S. Cl. CPC G06Q 10/06312; G06Q 50/06; G06Q 10/067

(57) ABSTRACT

A system, computer-implemented method, and a computer program product are provided for load profile management and cost sensitivity analysis. A baseline load profile is input via a user interface, wherein the baseline load profile is based on a set of equipment load profiles. A target load profile is generated based on a selected modification of the baseline load profile. The target load profile is compared with the baseline load profile. The comparison of the target load profile and the baseline load profile is output via the user interface.

### CROSS REFERENCE TO RELATED APPLICATIONS

This application is a non-provisional application claiming priority to U.S. Non-Provisional patent application Ser. No. 13/465,309, entitled “LOAD PROFILE MANAGEMENT AND COST SENSITIVITY ANALYSIS,” to Burke, filed May 7, 2012, and U.S. Provisional Patent Application, Ser. No. 61/530,646, entitled “METHOD AND APPARATUS FOR LOAD PROFILE MANAGEMENT AND COST SENISTIVITY ANALYSIS”, to Burke, filed Sep. 2, 2011, which are incorporated herein by reference for all purposes.

### FIELD OF THE PRESENT DISCLOSURE

The invention relates generally to energy management, and more specifically to a system, computer-implemented method, and computer program product for load profile management and cost sensitivity analysis.

### BACKGROUND

A facility manager may attempt to identify, modify and implement a load profile, an electrical engineering term for a graph of the variation in an electrical load versus time, which delivers a targeted cost reduction for a facility. The facility manager starts with, for example, a cost reduction target. A facility manager may then consider the large numbers of Equipment which consume energy and guess at which Equipment might have significant impact on total energy load and therefore constitute significant cost drivers. Once the facility manager has guessed which Equipment is significantly driving energy cost, the facility manager is faced with the challenge of combining the load profiles of various contributing Equipment. For example, the facility manager may desire to combine the load profiles of all HVAC units or all Equipment on a particular floor or department. Similarly, the facility manager may desire to create a facility load profile accounting for all, or all the selected, Equipment in the facility. This is often a process that is tedious and time-consuming for multiple reasons. Even where meters are in place on the desired Equipment, the physical installation may not contain combined data from the meters or a device for combining meter readings for the specified Equipment. Additionally, the software being used to retrieve the meter data may not be capable of combining meter data into preferred logical collections.

The facility manager creates a representative or baseline load profile for selected Equipment, such as all facility Equipment, or selected equipment believed to be significant cost drivers, etc. The baseline load profile is a representation of actual energy usage based on metered data for the selected Equipment.

The facility manager must then create a target load profile, that is, a new, modeled load profile with modified equipment loads, in an attempt to reduce the energy cost associated with the Equipment designated in the baseline load profile. The target load profile may be a modeled load profile with modifications made in energy usage, when compared to the baseline load profile. This process can be quite time consuming and tedious because the facility manager cannot readily predict the cost impact or cost sensitivities of load profile changes, thereby requiring the facility manager to make educated guesses. The facility manager then repeats this process, using an iterative process to configure the loads of relevant Equipment until the target load profile, or target cost reduction, is realized.

Finally, once this has been accomplished and the targeted load profile changes have been made to the physical equipment, the facility manager then waits a full billing period to verify the impact on cost due to changes made in the load profile. If the cost reduction targets have not been achieved, the facility manager starts the process again. Once the billing period is completed, a determination may be made if the costs of implementing the target load profile in the facility are significantly less than the potential savings to warrant an implementation of the target load profile.

The whole process is time-consuming, error prone, and is often too risky to execute during working hours because the targeted load profile changes may negatively affect production, sales, etc. Furthermore, the analysis process represents a single snapshot in time, and may not take into consideration all the relevant variables. For more advanced enterprises, the facility manager may simply export large quantities of energy load data to an Energy Domain Analyst, who then works off-line to create an optimized target load profile. This process is also time consuming, lacks repeatability, and lacks scale.

### SUMMARY

A system, computer-implemented method, and computer program product are provided for load profile management and cost sensitivity analysis. The system enables a user to create a target load profile for a facility and determine whether implementing the target load profile at the facility would be cost effective for the facility without requiring significant amounts of capital reconfiguring equipment or significant amount of time to be spent waiting for the end of any utility provider's billing cycle.

The system provides a user interface to enable the creation or input of a baseline load profile based on a set of equipment load profiles and the creation of a target load profile based on the baseline load profile. For example, a user creates a baseline load profile for normal operations of a facility's refrigeration Equipment and the facility's HVAC Equipment and creates a target load profile based on modifying the baseline load profile for a proposed reconfiguration of the facility's refrigeration Equipment and the facility's HVAC Equipment. Although a facility's load profile may combine many load profiles, this simplified example combines only two types of load profiles.

The system compares the baseline load profile with the target load profile. For example, the system makes a comparison of the target load profile with the baseline load profile, ensuring that the functioning of the facility is unaffected. The system outputs a comparison of the target load profile and the baseline load profile via the user interface. For example, the system outputs a cost differential based on the comparison of the target load profile with the baseline load profile and based on utility provider information for the load profiles, such as complex time-of-use tariffs. The cost differential enables a system user to decide whether implementing a target load profile that the user created for the facility would be cost effective for the facility without requiring significant amounts of capital to be spent reconfiguring equipment or significant amount of time to be spent waiting for the end of any utility provider's billing cycle.

### BRIEF DESCRIPTION OF THE DRAWINGS

Drawings of the preferred embodiments of the present disclosure are attached hereto so that the embodiments of the present disclosure may be better and more fully understood:

FIG. 1 presents a sample system of the present disclosure;

FIG. 2 presents a sample frame depicted by a user interface of the present disclosure;

FIG. 3 presents another sample frame depicted by a user interface of the present disclosure; and

FIG. 4 presents a sample method of the present disclosure.

### DEFINITIONS

As used herein, Facility Domain refers to the one or more facility, building, plant, operations platform, etc., consuming energy, and the power uses within such facilities, and expertise specifically related to such facilities, such as knowledge regarding building management, physical assets, power use, energy power consumption devices, and monitoring tools. A customer will have personnel, whether employees or contractors, with expertise in the Facility Domain, and capable of defining or identifying facility Performance Indicators, referred to as a facility manager.

As used herein, Energy Domain refers to energy consumption, use, distribution of use, energy consumption behavior, energy measurement, energy use measurement, key Performance Indicators for a business sector, etc., and the knowledge and expertise specific to such information. An Energy Domain Analyst, or simply “analyst,” is a person, whether employed by a customer, or contracted as an expert, with expertise in the Energy Domain and capable of defining or identifying energy use Performance Indicators.

As used herein, Business Domain refers to business or customer operations, revenue, revenue targets, budgeting, planning, costs, cost goals, etc., and the knowledge and expertise relevant to a business. A customer will have personnel, whether employees or contractors, who are experts in the Business Domain capable of defining or identifying business Performance Indicators. Energy Resource Management, as used herein, refers to management of energy consumption and its by-products at the Business Domain level. It is to be understood that various experts and analysts referred to herein may be one or more person, an employee or contractor, and that a single person may qualify as an expert in more than one Domain.

As used herein, Equipment refers to one or more energy consuming devices, such as Heating, Ventilation, and Air Conditioning (HVAC) systems, water pumps, compressors, engines, lighting systems, etc. The term Equipment may mean a single piece of equipment or a logical grouping of several pieces of equipment. For example, Equipment may refer to a group of electrical devices in a single location, such as on a floor of a facility or at a machine bay or on a rig. Similarly, Equipment may be grouped by type of device, such as all the HVAC units for a facility.

As used herein, Business Intelligence refers to software-based tools used to extract, create, and/or import key Performance Indicators for a customer. As used herein, Performance Indicators refer to data and/or variables regarding energy consumption, energy resource management, costs, usage, etc. that can be used to generate insights into energy use and efficiency. Performance Indicators refer to information that may be used in creating, modifying, describing and displaying load profiles. For example, a facility Performance Indicator may be a facility's HVAC load profile, which combines the facility's energy demand measured by meter 1 for HVAC unit 1 and the facility's energy demand measured by meter 2 for HVAC unit 2.

As used herein, Domain Variables refer to the data and the variables (such as kilowatts, kilowatt hours, etc.) for all of the various domains, such as the Facility Domain, the Energy Domain, and the Business Domain. As used herein, Domain Mapping refers to the translation of Performance Indicators from one domain to a set of Performance Indicators in another domain. For example, a business Performance Indicator may be a number of sales per kilowatt hour, and an energy Performance Indicator may be the demand cost for the collective lighting systems across ten buildings, while a facility Performance Indicator may be the average temperature during a period of sales.

As used herein, an Equipment load profile is a graph of the variation in the electrical load versus time for a specific piece of Equipment. The equipment load profile is metered by a power meter on the piece of Equipment. In contrast, a load profile is an electronic graph of the variation in the electrical load versus time which is created by an Energy Management System user and related to selected Domain Variables. As used herein, a stored load profile is simply a load profile which has been saved. Various load profiles may be created and/or modified until one of the load profiles enables achievement of a goal, thereby becoming a target load profile. As used herein, a target load profile is an electronic load profile based on a targeted energy usage, or other targeted variable.

### DETAILED DESCRIPTION OF SOME EMBODIMENTS

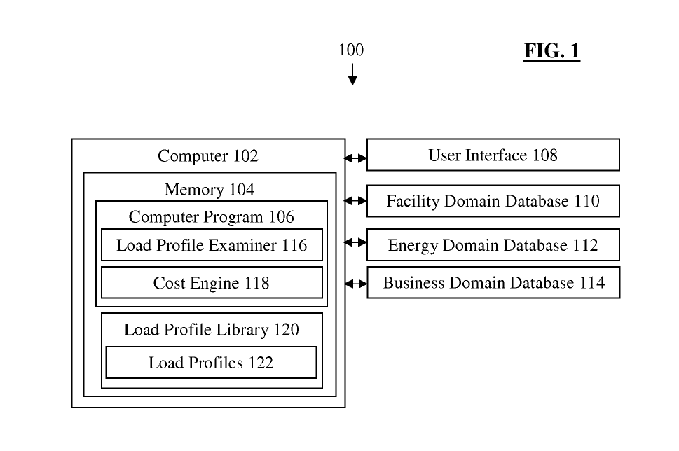

FIG. 1 presents a sample system 100 of the present disclosure, which may also be referred to as an energy management system 100. The system 100 includes a computer 102, a memory 104, a computer program 106, and a user interface 108. The computer program 106 is stored in the memory 104 and executed by the computer 102 to communicate via the user interface 108 with system users.

The computer 102 also communicates with a Facility Domain database 110, an Energy Domain database 112, and a Business Domain database 114, which may be mutually exclusive databases. The computer program 106 includes a load profile examiner 116 and a cost engine 118. The computer 102 also communicates with a load profile library 120, which includes load profiles 122. Although FIG. 1 depicts one of each of the elements 102-122, the system 100 may include any number of each of the elements 102-122.

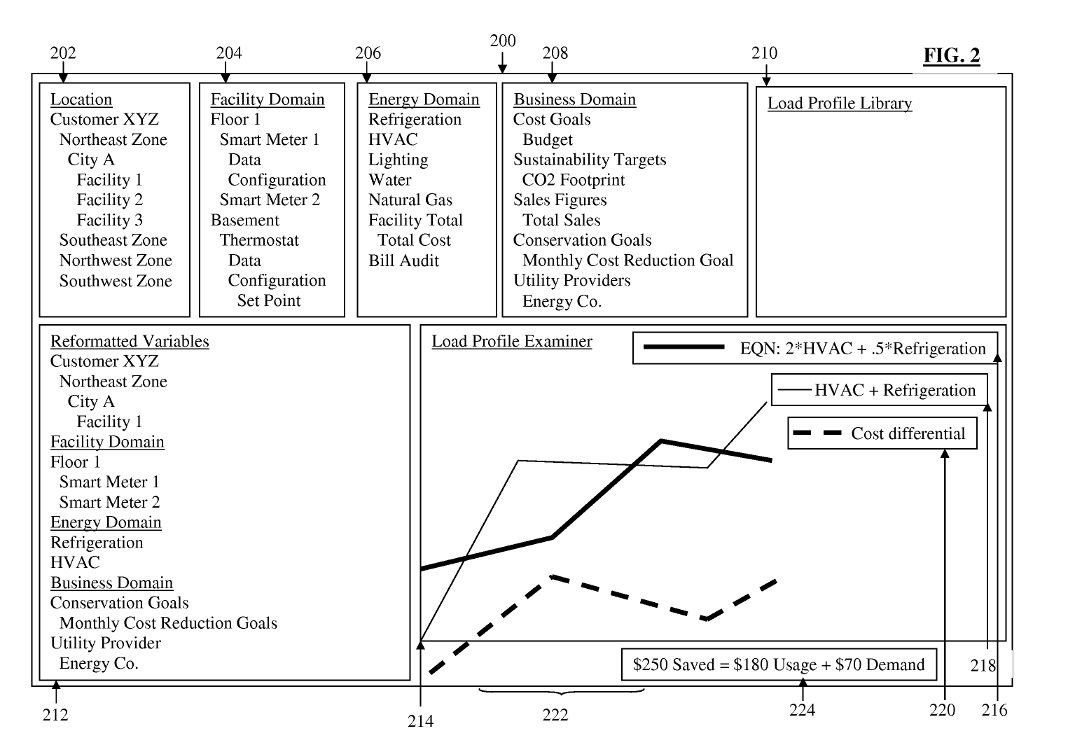

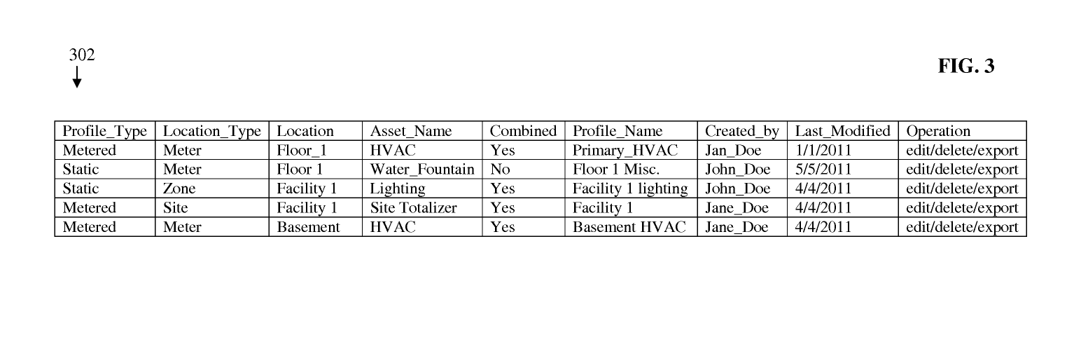

The load profile examiner 116 creates load profiles, imports load profiles, compares load profiles, and graphically depicts all comparisons between load profiles. The cost engine 118 calculates cost differentials based on comparisons of load profiles and based on utility provider information, such as complex time-of-use tariffs, and can decompose the cost differentials into cost drivers. The load profile library 120 stores the load profiles 122 accessed by the system 100. An example of the load profile library 120 is described below in reference to FIG. 3. The load profiles 122 are created by the user of the system 100, and are combinations or modifications of other load profiles. An example of the load profiles 122 is described below in reference to FIG. 2. The computer program 106 may synchronize a target load profile with the metered data from the target load profile's component load profiles to enable comparisons based on metered data, without the need to reconfigure the equipment associated with the metered data. Metered data may refer to data previously measured by a meter and/or data that is currently measured by a meter.

Examples of data in the Business Domain include budgets, corporate energy conservation goals, sales transactions, operational expenses, energy cost, demand cost, and transaction and energy cost. Examples of data in the Energy Domain, upon which data in the Business Domain may be based, include calculated data such as real usage, reactive usage, power factor, maximum demand, kilovolt-ampere reactive (kVAr), kilovolt-ampere reactive hours (kVArh), power factor, kilowatts during a base time of use, kilowatts during an intermediate time of use, kilowatts during a sub-peak time of use, kilowatts during a peak time of use, kilowatt hours during a base time of use, kilowatt hours during an intermediate time of use, kilowatt-hours during a sub-peak time of use, and kilowatt hours during a peak time of use. Examples of data in the Facility Domain, upon which the data in the Energy Domain may be based, include raw data such as meter data, meter configuration, metered data, a sampling frequency, heating ventilation and air conditioning (HVAC) data, lighting data, humidity and, temperature, and control data such as setpoints.

The computer program 106 enables a user to create a target load profile for a facility and decide whether implementing the target load profile at the facility would be cost effective for the facility without requiring significant amounts of capital to be spent reconfiguring equipment or significant amount of time to be spent waiting for the end of any utility provider's billing cycle. The computer program 106 either inputs or creates a baseline load profile based on a set of equipment load profiles, and then creates a target load profile based on the baseline load profile via the user interface 108. For example, a user creates a baseline load profile for a facility's normal refrigeration energy costs and the facility's normal HVAC energy costs. The user may input the baseline load profile and modify the baseline load profile to create a target load profile for a proposed reconfiguration of a facility's refrigeration Equipment and the facility's HVAC Equipment. Alternately, the user can also create the target load profile in a manner similar to that used to create the baseline load profile. By creating the target load profile that combines the metered data from the HVAC load profile and the metered data from the refrigeration load profile, the computer program 106 enables the operation of the associated HVAC system and refrigeration system to continue unaffected while the computer program 106 makes comparisons between the target load profile based on the metered data and the baseline load profile.

Although a facility's load profile may combine many component load profiles, this simplified example combines only two types of component load profiles. For example, a facility's baseline load profile and/or target load profile may combine load profiles for each of the facility's refrigeration system, HVAC system, lighting system, water system, and natural gas system.

The computer program 106 may reformat load profiles to ensure compatibility between load profiles and to create both baseline load profiles and target load profiles. For example, the computer program 106 may reformat a load profile for smart meters from the Facility Domain database 110 and load profiles for refrigeration system costs and HVAC system costs from the Energy Domain database 112 to ensure that these load profiles are compatible, thereby enabling comparison of these load profiles or the creation of a baseline load profile based on these load profiles.

The target load profile may be a static load profile or a metered primary load profile. For example, the target load profile may be based on historical data measured on a specific day when the user reconfigured a facility's Equipment to operate in a specific manner. In another example, the target load profile may be a metered load profile based on current data measured from the facility's Equipment that the user has reconfigured to operate in a specific manner.

The load profile examiner 116 compares the target load profile with the baseline load profile. For example, the load profile examiner 116 makes a comparison of the target load profile with metered data from the baseline load profile, thereby ensuring that the functioning of the facility is unaffected.

The load profile examiner 116 outputs the comparison of the target load profile and the baseline load profile via the user interface 108. For example, the load profile examiner 116 outputs a cost differential based on calculations made by the cost engine 118 using the comparison of the target load profile with the baseline load profile and based on utility provider information for the load profiles, such as complex time-of-use tariffs.

The cost engine 118 may enable a system user to select utility provider information and tariff information to be applied to the target load profile. For example, a system user may conduct a “what-if” scenario by substituting alternative utility provider information and alternative tariff information for a facility's utility provider information and tariff information to determine if the customer could reduce expenses by changing utility providers.

The cost engine 118 may decompose a load profile into billing cost factors, such as demand, usage, and penalties costs, including time-of-use sensitivities, and may decompose aggregate load profiles into constituent load profiles and their respective relative demand and cost contributions and cost sensitivities, etc. The cost engine 118 may analyze, decompose, and otherwise manipulate the load profile data to indicate the individual cost drivers across selected Equipment, Equipment groups, etc., such as HVAC, refrigeration, and lighting. The decomposition process may analyze a specified load profile, such as a baseline load profile, and indicate which particular Equipment, locations, energy usage or time-of-use, are driving energy costs. For example, the cost engine 118, based on the loaded demand, tariffs, etc., may indicate that the most significant cost driver for a facility is the HVAC Equipment, and provide a cost sensitivity graphic related to the HVAC Equipment, etc.

The computer program 106 may automatically generate suggested energy usage and/or time-of-use changes to provide a targeted cost reduction and output these suggestions via the user interface 108. For example, the computer program 106 may analyze a targeted costs reduction, −10% for example, and calculate and output to the user a suggested reduction of load pulled by the HVAC Equipment throughout the facility, resulting in a one degree increase in facility temperature during business hours, will result in a targeted cost reduction.

The computer program 106 can, based on selections and limitations entered by the user, offer solutions which fit the user's priorities. For example, the facility manager can specify that a temperature change above a certain temperature during business hours is not allowed as a suggestion to reduce cost. The computer program 106 can provide alternative suggestions, such as temperature increase during off-peak hours, reduction in floor lighting, etc., to reduce energy costs. The computer program 106 provides the user with enough flexibility to automatically determine, using the data provided by the computer program 106, to reach a targeted cost reduction without changes to essential equipment or particular energy usage which is desired to be omitted from the analysis. The computer program 106 may also account for physical plant or facility modifications which have not been implemented but can be modeled by the system. For example, a facility manager can select a Performance Indicator associated with providing window tinting on the south-facing windows, or installation of high-efficiency HVAC systems on Floor 3, etc., and the computer program 106 may provide the anticipated cost changes due to such changes. Obviously, such outputs require inputting known or published data related to the efficiencies associated with the physical devices.

This cost differential output by the load profile examiner 116 enables a system user to decide whether implementing a target load profile at a facility that the user created for the facility would be cost effective for the facility without requiring significant amounts of capital to be spent reconfiguring equipment or significant amount of time to be spent waiting for the end of any utility provider's billing cycle. The load profile examiner 116 may provide the user with data such as cost differences between load profiles, selected and historical equipment loads or demands, load modifications, historical loads, cost sensitivities, historical and anticipated costs, relevant data about utility providers and tariffs, etc. A cost sensitivity is a cost gradient as a function of load profile changes, namely of usage and time-of-use, or demand and time. Cost sensitivity can be calculated and displayed for a piece or group of equipment, for a facility, location, floor, system, etc.

If the computer program 106 predicts that the desired cost reductions will not been achieved, the facility manager may simply modify the target load profile and gets updated, modified, associated cost output from the cost engine 118. If the estimated costs generated by the computer program 106 differ from the actual costs after the utility bill is available from the utility provider, and the desired cost reductions have not been achieved, the process can be refined. For example, the facility manager may create a new baseline load profile including additional or different Equipment loads or make corrections to better model the actual load and demand, tariffs, and other data and calculations used by the computer program 106. However, the expected success rate for estimated costs is high because of the benefits of the computer program 106.

FIG. 2 presents a sample frame 200 presented by the user interface 108 in FIG. 1 of the present disclosure. The frame 200 includes a location column 202, a facility domain column 204, an energy domain column 206, a business domain column 208, a load profile library column 210, a reformatted variables column 212, and a load profile examiner column 214.

The location column 202 includes a row for customer XYZ, which includes indented rows for a northeast zone, a southeast zone, a northwest zone, and a southwest zone. If the indented row for the northeast zone is selected via the user interface 108, the location column 202 depicts a double indented row for the city A. If the double indented row for the city A is selected via the user interface 108, the location column 202 depicts triple indented rows for facility 1, facility 2, and facility 3. If the triple indented row for facility 1 is selected via the user interface 108, the computer program 106 receives this selection of the facility 1 location. Subsequent selections of variable identifiers may be based on the location selection. For example, the computer program 106 receives the selection of the triple indented row for facility 1 in the location column 202, presents variables that correspond to facility 1 in city A in the northeast zone for selection in the columns 204-208, and identifies this location selection in the reformatted variables column 212.

The Facility Domain column 204 includes rows for floor 1 and basement, which correspond to facility 1 selected from the location column 202. If the row for floor 1 was selected via the user interface 108, the Facility Domain column 204 may depict indented rows for smart meter 1 and smart meter 2. If the indented row for smart meter 1 was selected via the user interface 108, the Facility Domain column 204 may depict double indented rows for data and configuration. If the row for the basement of facility 1 is selected via the user interface 108, the Facility Domain column 204 may depict a double indented row for a thermostat. If the double indented row for the thermostat of facility 1 was selected via the user interface 108, the Facility Domain column 204 may depict triple indented row for data and configuration of the thermostat. If the triple indented row for the configuration of the thermostat was selected via the user interface 108, the Facility Domain column 204 may depict a quadruple indented row for the set point of the thermostat. In this example, since the computer program 106 receives the selections of the indented rows for the smart meters in the Facility Domain column 204, the computer program 106 identifies these selections in the reformatted variables column 212.

The Energy Domain column 206 includes rows for refrigeration, HVAC, lighting, water, natural gas, facility total, and bill audit. If the row for facility total is selected via the user interface 108, the Energy Domain column 206 depicts an indented row for total cost. In this example, since the computer program 106 receives the selections of the rows for refrigeration and HVAC in the Energy Domain column 206, the computer program 106 identifies these selections in the reformatted variables column 212.

The Business Domain column 208 includes rows for cost goals, sustainability targets, sales figures, conservation goals, and utility providers. If the row for sustainability targets was selected via the user interface 108, the Business Domain column 208 may depict an indented row for CO2 footprint. If the row for sales figures was selected via the user interface 108, the Business Domain column 208 may depict an indented row for total sales. If the row for cost goals is selected via the user interface 108, the Business Domain column 208 may depict an indented row for budget. If the row for conservation goals is selected via the user interface 108, the Business Domain column 208 may depict an indented row for monthly cost reduction goal. If the row for utility providers is selected via the user interface 108, the Business Domain column 208 may depict an indented row for Energy Co. In this example, since the computer program 106 receives the selections of the indented row for monthly cost reduction goal and Energy Co. in the Business Domain column 208, the computer program 106 identifies this selection in the reformatted variables column 212.

The load profile library column 210 depicts load profiles that a user may select via the user interface 108, which may serve as an alternative to creating a target load profile. An example of the load profile library 120 is described below in reference to FIG. 3.

The reformatted variables column 212 includes references to previous selections. For example, the reformatted variables column 212 depicts the selection of facility 1 in city A in the northeast zone for customer XYZ as the location selection, the smart meters 1 and 2 on floor 1 of facility 1 as the variables selected from the Facility Domain, the cost of the refrigeration system and the cost of the HVA system for facility 1 as the variables selected from the Energy Domain, and the monthly conservation goal and the utility provider information for Energy Co. as the variables selected from the Business Domain.

The load profile examiner column 214 may include text 216 entered by a customer via the user interface 108 to generate a target load profile based on a baseline load profile. Alternatively, the text 216 may be automatically generated by the computer program 106 based on measuring relationships between Equipment load profiles. Complicated computer programs are typically written in computer languages by either software vendors or hired experts, and typically require a lengthy software development life cycle before the computer program is laboriously compiled into executable language that may have to wait before it can be loaded into a live data system. In contrast, the text 216 may be customer-entered based on a simple text that the customer can easily understand, and the text 216 may be interpreted and executed quickly by a live data system without the need for compilation or the need to wait before the text can be used by the live data system. The computer program 106 provides customers with the capability of achieving operational scalability by drastically reducing the development life cycle to create and compare a large number of load profiles through the elimination of middlemen such as software vendors and hired experts during a greatly accelerated development process.

In this example, the text 216 represents a target load profile that is based on modifications to a baseline load profile. The target load profile is represented as an equation created and entered by the user, in which the target load profile for facility 1 is a cost that equals 2 multiplied by the HVAC cost plus 0.5 multiplied by the refrigeration cost. For this example, the system user may have reconfigured the HVAC equipment and refrigeration equipment to optimize facility 1's operation and cost. The system user may have attempted to achieve a 10% cost reduction goal for facility 1 while maintaining facility 1's operational requirements by increasing the operation of the HVAC equipment while decreasing the operation of the refrigeration equipment. In this example, the system user reconfigured the HVAC equipment to pre-cool facility 1 before peak energy usage hours, which enabled a reduction in the operation of the refrigeration equipment during peak energy usage hours, when a disproportionally large amount of the costs are incurred. The Equipment load profiles for the HVAC equipment and the refrigeration equipment were measured by meters during this reconfigured operation, resulting in an HVAC cost that was double the previous HVAC cost and a refrigeration cost that is half of the previous refrigeration cost. If the previous refrigeration cost was significantly more than the previous HVAC cost, this Equipment reconfiguration enabled the system user to achieve the desired goal of the 10% reduction in operating costs. Therefore, the system user created and entered the text 216 that reflected this potential reconfiguration of equipment. The text 216 may represent either a static load profile, or the text 216 may represent metered data from the facility, either which may be referred to as the target load profile.

The text 216 also indicated that a solid bold line will graphically represent the target load profile equation in the load profile examiner column 214. For example, the solid bold line in the load profile examiner column 214 graphically indicates that the target load profile slowly increased, rapidly increased, and then slowly decreased during a day.

The load profile examiner column 214 includes text 218 that indicates that the baseline load profile that represents the addition of the HVAC load profile to the refrigeration load profile is graphically represented by a solid line. For example, the solid line in the load profile examiner column 214 graphically indicates that the baseline load profile rapidly increased, practically flat-lined, increased, and then rapidly increased again during the day.

The load profile examiner column 214 includes text 220 that indicates that a comparison between the target load profile and the baseline load profile is graphically represented by a bold dashed line. For example, the bold dashed line in the load profile examiner column 214 graphically indicates that the cost engine 118 calculated that the cost savings differential between the target load profile and the baseline load profile increased, decreased, and then increased again during the day.

The load profile examiner column 214 includes peak energy usage hours 222 that indicate when a disproportionally large amount of the costs are incurred. The graphic representations in the load profile examiner column 214 indicate that both the target load profile and the baseline load profile are in a complex time-of-use tariff, the greatest cost differentials occur during the peak energy usage hours 222, and the target load profile has a lower peak demand than the baseline load profile.

The load profile examiner column 214 includes cost differential text 224 that indicate the cost differential calculated by the cost engine 118 for the time period graphically represented. For example, the cost differential text 224 indicates that the energy costs represented by the proposed implementation of the target load profile to facility 1 is $250 less than the energy costs represented by the baseline load profile. In this example, the cost engine 118 decomposes the cost differential into multiple cost drivers of $180 in usage savings and $70 in demand savings.

The load profile examiner 116 may save the comparison of the load profiles in a library for use as a cost differential. For example, the computer program 106 may enable the system user to save the target load profile represented by the text 216 as one of the load profiles 122 in the load profile library 120 and save the comparison between the target load profile and the baseline load profile as a cost differential load profile in the load profile library 120. The system user may subsequently retrieve the load profiles 122 from the load profile library 120 for analysis. For example, the system user may retrieve the cost differential load profile as static data from the load profile library 120 to analyze the difference between the target and baseline load profiles on the day the load profiles were compared. In another example, the system user may retrieve the cost differential load profile as metered data from the load profile library 120 to analyze the difference between the target and baseline load profiles for the day subsequent to when the load profiles were retrieved.

The frame 200 may be part of a larger display screen that includes fields for users to enter commands to make, edit, and store selections and transform text. The user interface 108 in FIG. 1 may output a display screen that includes the frame 200 in FIG. 2 in response to a search based on search criteria input via the user interface 108 in FIG. 1. For example, a system user may enter search criteria to request to review the frame 200, which corresponds to the selections and text previously entered.

FIG. 3 presents a sample frame 300 presented by the user interface 108 in FIG. 1 of the present disclosure. The frame 300 includes a load profile library 302. A system user may instruct the computer program 106 to import load profiles from the load profile library 302 into the load profile examiner column 214 in FIG. 2.

The load profile library 302 includes rows and columns such as a “profile type” column, a “location type” column, a “location” column, an “asset name” column, a “combined” column, a “profile name” column, a “created by” column, a “last modified” column, and an “operation” column. The load profile library 302 identifies information for stored load profiles and enables system users to retrieve stored load profiles. For example, after the first row in the load profile library 302 that includes the headings for these columns, the “profile type” column specifies whether each load profile reflects currently metered data or static historic data, the “location type” column specifies a geographic area for each load profile, and the “location” column specifies a physical location for each load profile. Continuing this example, the “asset name” column specifies the Equipment assigned to each load profile, the “combined” column specifies whether each load profile includes a combination of other load profiles, a “profile name” column specifies a name assigned by a system user to each load profile, a “created by” column specifies a system user who created each load profile, and the “last modified” column specifies when each load profile was created. By selecting from the corresponding options of edit, delete, and export in the “operation” column, a system user instructs the computer program 106 to edit the corresponding load profile, to delete the corresponding load profile, or to export the corresponding load profile.

Because the frames 200-300 in FIG. 2-FIG. 3, respectively, are samples, the frames 200-300 could vary greatly in appearance. For example, the relative sizes and positioning of the columns and rows are not important to the practice of the present disclosure. The frames 200-300 can be depicted by any visual display, but are preferably depicted by a computer screen. The frames 200-300 could also be output as reports and printed or saved in electronic format, such as portable document file (PDF). The frames 200-300 can be part of a personal computer system and/or a network, and operated from system data received locally, by the network, and/or on the Internet. The frames 200-300 may be navigable by a user. Typically, a user can employ a touch screen input or a mouse input device to point-and-click to a location on the frames 200-400 to manage the text on the frames 200-300, such as a selection that enables a user to drag the text from at least some of the columns 202-210 and drop the text into the reformatted variables column 212. Alternately, a user can employ directional indicators, or other input devices such as a keyboard. The text depicted by the frames 200-300 are examples, as the frames 200-300 may include a much greater amount of text.

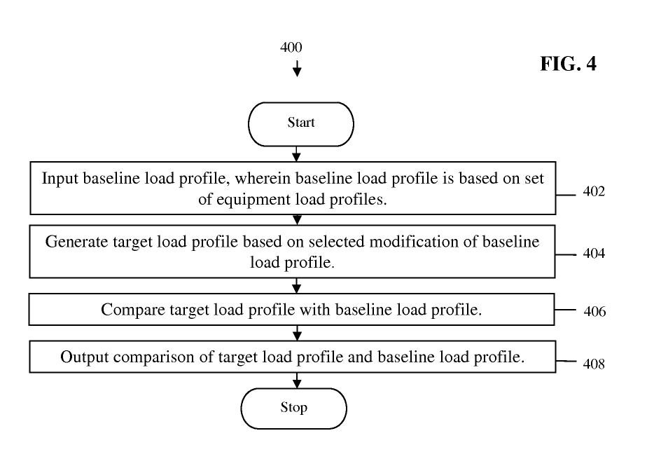

FIG. 4 presents a sample method 400 of the present disclosure. The energy management system 100 in FIG. 1 may execute the method 400 to decide whether implementing a target load profile at a facility that the user created for the facility would be cost effective for the facility without requiring significant amounts of capital to be spent reconfiguring equipment or significant amount of time to be spent waiting for the end of any utility provider's billing cycle.

In box 402, a baseline load profile is input, wherein the baseline load profile is based on set of equipment load profiles. For example, the computer program 106 inputs facility 1's baseline load profile from the load profile library 120. Alternatively, the computer program 106 may enable the user to create facility 1's baseline load profile by selecting a set of equipment load profiles.

In box 404, a target load profile is generated based on selected modification of a baseline load profile. For example, the computer program 106 receives selections from the user of modifications to facility 1's baseline load profile to create facility 1's target load profile, represented by the text 216 in FIG. 2.

In box 406, a target load profile is compared with a baseline load profile. For example, the computer program 106 compares facility 1's target load profile of static data with facility 1's baseline load profile of currently metered data without effecting the operation of equipment in facility 1.

In box 408, a comparison of a target load profile and a baseline load profile is output. For example, the computer program 106 outputs the load profile examiner column 214 in FIG. 2, which indicates that the proposed implementation of the target load profile that the user created for facility 1 to facility 1 would be calculated to save $250 for the day.

The method 400 may be repeated as desired. Although this disclosure describes the boxes 402-408 executing in a particular order, the boxes 402-408 may be executed in a different order.

The systems, methods, and computer program products in the embodiments described above are exemplary. Therefore, many details are neither shown nor described. Even though numerous characteristics of the embodiments of the present disclosure have been set forth in the foregoing description, together with details of the structure and function of the present disclosure, the present disclosure is illustrative, such that changes may be made in the detail, especially in matters of shape, size and arrangement of the components within the principles of the present disclosure to the full extent indicated by the broad general meaning of the terms used in the attached claims. The description and drawings of the specific examples above do not point out what an infringement of this patent would be, but are to provide at least one explanation of how to make and use the present disclosure. The limits of the embodiments of the present disclosure and the bounds of the patent protection are measured by and defined in the following claims.

The following are incorporated herein by reference for all purposes: U.S. patent application Ser. No. 13/155,222, to Burke, entitled Jun. 7, 2011; U.S. patent application Ser. No. 13/219,361, to Burke, filed Aug. 26, 2011; U.S. patent application Ser. No. 13/223,632, filed Sep. 1, 2011, to Burke; U.S. patent application entitled “Estimating and Optimizing Cost Savings for Large Scale Deployments using Load Profile Optimization”, to Burke, filed concurrently herewith; U.S. patent application entitled “Dynamic Tagging To Create Logical Models and Optimize Caching in Energy Management Systems”, to Burke, filed concurrently herewith; and U.S. Patent Application entitled “Load Profile Management and Cost Sensitivity Analysis”, to Burke, filed concurrently herewith.

1. A load profile and energy management system, comprising:
a facility having a plurality of electrical equipment, each piece of electrical equipment having an initial operating schedule and initial set points;
a plurality of electrical meters providing metered data regarding energy usage by the electrical equipment, a meter associated with each piece of electrical equipment;
a facility computer constructed to communicate with the plurality of electrical meters so as to create, using the electrical equipment initial operating schedules and initial set points, a modelled, baseline facility load profile using the provided metered data regarding energy usage by the electrical equipment;
the facility computer constructed to create a modelled, modified facility load profile by modelling modified operating schedules and modified set points for selected pieces of electrical equipment; and
the facility computer constructed to output a control command to the electrical equipment to take an action to implement the modified facility load profile.

2. The load profile and energy management system of claim 1, wherein the pieces of equipment of the plurality of electrical equipment is selected from the group consisting of: HVAC systems, water pumps, natural gas systems, compressors, engines, lighting systems, refrigeration systems, electrical energy consuming devices, and groupings thereof.

3. The load profile and energy management system of claim 1, wherein the electrical meters are smart meters connected to a computerized network.

4. The load profile and energy management system of claim 1, wherein the provided metered data is selected from the group consisting of: real-time data, sampled data, stored data, historical data, live data, and combinations thereof.

5. The load profile and energy management system of claim 1, the facility computer constructed to receive and utilize additional data to create the modified facility load profile such as HVAC data, lighting data, meter configuration data, humidity data, and temperature data.

6. The load profile and energy management system of claim 1, the facility computer further constructed to model multiple modified facility load profiles and compare the multiple modified facility load profiles.

7. The load profile and energy management system of claim 6, the facility computer further constructed to create modelled, modified facility load profiles until an energy-usage or cost target is achieved.

8. The load profile and energy management system of claim 1, the facility computer constructed to synchronize a modified facility load profile with the metered data.

9. The load profile and energy management system of claim 1, wherein the facility baseline load profile is a combination of multiple electrical equipment load profiles.

10. The load profile and energy management system of claim 1, the facility computer constructed to calculate a cost differential based on a comparison of the facility baseline load profile and the modified facility load profile.

11. The load profile and energy management system of claim 1, the facility computer constructed to decompose a facility baseline load profile and a modified facility load profile into billing cost factors, constituent electrical equipment load profiles, and identify significant cost drivers.

12. The load profile and energy management system of claim 1, the facility computer constructed to automatically generate suggested changes to the facility baseline load profile, including changes to energy usage or time-of-use, to meet a targeted cost or energy-usage reduction.

13. The load profile and energy management system of claim 1, the computer constructed to automatically generate multiple modified facility load profiles.

14. The load profile and energy management system of claim 1, the facility computer constructed to create the modified facility load profile by modelling: a reconfiguration of electrical equipment at the facility, a substitution of electrical equipment at the facility, or an addition of high-efficiency electrical equipment or other energy-saving modification to the facility.

15. The load profile and energy management system of claim 1, wherein the facility computer is constructed to communicate data over the internet between the computer and secondary facilities or between the computer and the meters.

16. The load profile and energy management system of claim 1, wherein the control command is to implement a conservative policy via the facility electrical equipment or for a specified piece of electrical equipment to take a specified action.

17. The load profile and energy management system of claim 16, wherein implementation of the control command changes the state of the facility.

18. The load profile and energy management system of claim 15, the facility computer constructed to create a plurality of secondary facility load profiles for geographically remote secondary facilities, and compare the modified facility load profile to one or more of the secondary facility load profiles.

19. The load profile and energy management system of claim 18, wherein the modified facility load profile includes a modified set point for a piece of electrical equipment in the facility, and wherein the modified set point is output to similar electrical equipment located in the one or more secondary facilities.

20. The load profile and energy management system of claim 1, the facility computer constructed to have secondary facility load profiles track a selected baseline or modified facility load profile.

21. The load profile and energy management system of claim 1, the facility computer constructed to provide alerts upon occurrence of selected current energy-usage as provided by the meters, or to create a trigger for a prescribed set of actions which change the state of energy-usage of a facility.

22. The load profile and energy management system of claim 1, wherein at least one of the pieces of electrical equipment is an HVAC unit with an associated thermostat having an initial operating schedule and associated initial temperature set points; and wherein the facility computer is constructed to output a control command to the thermostat to take a specified action.

23. The load profile and energy management system of claim 22, wherein the facility computer is constructed to compare the modified facility load profile with the baseline facility load profile, calculate a cost differential between the modified and baseline facility load profiles, decompose the cost differential into multiple cost drivers.

24. A method of managing the energy load of a facility having a plurality of electrical equipment, the method comprising:
receiving from a plurality of electrical meters over a network, metered data regarding energy usage by the electrical equipment at the facility;
creating a computer-modelled facility baseline load profile based on the received metered data regarding energy usage by the electrical equipment at the facility;
creating a plurality of modified facility load profiles based on computer-modelled modifications to the facility baseline load profile;
comparing the baseline and modified load profiles, and selecting a modified facility load profile showing, if implemented, a reduction in energy-usage at the facility compared to the baseline load profile; and
outputting a control command to take an action to implement the modified facility load profile.
